(19) United States
(12) Patent Application Publication
(10) Pub. No.: US 2002/0036170 A1
(43) Pub. Date: Mar. 28, 2002

(54) Lateral flower plasma separation device

(76) Inventors: Michael A. Harvey, Spofford, NH (US); Daniel S. Osborn, Sullivan, NH (US); John L. Tonkinson, Keene, NH (US)

Correspondence Address: Brian D. Voyce, Suite C204, 1100 Possum Trot Road, North Myretle Beach, SC, 29582, US

(21) Appl. No.: 09/927,965

(22) Filed: Aug. 10, 2001

Related U.S. Application Data
(60) Provisional application No. 60/224,616, filed on Aug. 11, 2000.

(51) Int. Cl. G01N 21/00; B01D 15/08

(52) U.S. Cl. 210/656; 435/2; 422/60; 436/170

(57) ABSTRACT

The present invention relates to a novel device for separating plasma from a whole blood sample on a treated microporous membrane. An advantage of the present invention is that the sample can be assayed on the membrane after separation has occurred. A lateral flow chromatographic assay membrane has a sample application zone, a separation zone, and an analysis zone. An erythrocyte binding agent is added to the membrane in an amount sufficient to bind any erythrocytes present in the sample. Methods for using such devices are disclosed also.

### RELATED APPLICATION

The present invention is related to and claims the benefit of an earlier filed provisional application, Ser. No. 60/224,616.

### TECHNICAL FIELD

The present invention relates to a novel device for separating plasma from a whole blood sample on a treated microporous membrane. An advantage of the present invention is that the sample can be assayed on the membrane after separation has occurred. A lateral flow chromatographic assay membrane has a sample application zone, a separation zone, and an analysis zone. An erythrocyte binding agent is added to the membrane in an amount sufficient to bind any erythrocytes present in the sample. Methods for using such devices are disclosed also.

### BACKGROUND ART

The problem of using whole blood for chromatographic assays having plasma based chemistries has created numerous solutions, many of which are based on erythrocyte aggregation.

U.S. Pat. No. 5,262,067 discloses a lateral flow, non-hemolyzing plasma separation device. Lectin or erythrocyte antibodies are used to aggregate erythrocytes. Glass fibers are coated with polyvinyl alcohol or polyvinyl acetate, to form a size exclusion or sieving process.

EP 295,526 also discloses a lateral flow plasma separation device that uses a lectin, however, a bibulous, hydrophilic matrix is required. Again, the erythrocyte aggregating material is used to create cellular aggregates that become fixed within the bibulous matrix, i.e., a size exclusion process.

### DISCLOSURE OF THE INVENTION

The present invention encompasses a novel device for separating plasma from a whole blood sample on a treated membrane, whereby the sample can be assayed thereon after separation has occurred. No sample transfer is necessary. A 1 micron to 20 micron porosity lateral flow chromatographic assay membrane can be used, eliminating extensive reformulation of chemistries for existing plasma based chromatographic assays. Suitable membrane materials having the requisite porosity, chromatographic properties, and binding characteristics include cellulose acetate, nitrocellulose, nylon, and polyethersulfones, polyvinylidene fluoride, as well as combinations or composites of these materials. These membranes can be either unsupported or supported with conventional materials, such as non-woven or woven polymers. An erythrocyte binding agent (EBA) is added to the membrane, associating therewith. (For the purposes of the present invention an EBA refers to any material that attaches to, binds to, or otherwise associates with the surface of red blood cells so as to retard lateral migration through the interstial spaces of the membrane). Preferably, the membrane is treated with the EBA in either a gradient concentration fashion or in a series of transverse, i. e, perpendicular to the flow direction, rows of increasing concentration. Suitable EBAs include either an anti-erythrocyte antibody or a lectin, preferably concananvalin A (Con A), which binds to sugar residues on the membranes of the red blood cells and white blood cells. In order to decrease the separation time and increase the sample capacity, a wick, is placed at the membrane distal to a sample application zone.

The plasma created by the present device is quite good for analysis on the distal end of the membrane, even if treated with an anti-coagulant. Red blood cells and nucleated cells are removed from whole blood without hemolysis and the concomitant presence of hemoglobin in the analysis zone. Recoverable levels of human serum proteins migrate to the analysis zone. Even glucose levels are unaffected by the presence of the EBA. The present invention is suitable for binding assays, such as immunoassays or nucleic acid assays, as well as any other binding assay format requiring a plasma sample as opposed to a whole blood sample.

In a preferred embodiment, the S&S device has a sample application pad added to one end of the chromatographic membrane. If comprised of glass fibers, then the application zone may be treated with a moisture-retaining agent such as polyethylene glycol.

Unlike the prior art, the present device does not use only size exclusion to separate erythrocytes from plasma. The present device does not require a transit of plasma through a dimension of a membrane, matrix, or the like whereby erythrocyte size is used to separate plasma from blood cellular components. The present device uses an anti-erythrocyte binding agent in a bound condition as opposed to coagulating agents, agglutinating agents, or other erythrocyte modifying agents that are not bound to a membrane.

One uses the present device in the following manner. First, one applies a whole blood sample to a 1 micron to 20 micron porosity lateral flow chromatographic assay membrane having a sample application zone, a separation zone, and an analysis zone on which is immobilized an analyte binding reagent, and an erythrocyte binding agent added to the separation zone of the membrane. Second, one allows sufficient time for any erythrocytes in the sample to bind to the binding agent, thereby separating plasma from the sample. Third, one further allows sufficient time for the sample plasma to migrate through the separation zone and into the analysis zone. Fourth one analyzes the migrated plasma to determine the presence or amount of an analyte.

### BRIEF DESCRIPTION OF THE DRAWINGS

FIG. 1 is a diagrammatic view of a suitable chromatographic device.

FIG. 2 is a graph showing protein amounts from serum samples in the read zone of a preferred embodiment.

FIG. 3 is a graph showing protein amounts from whole blood samples in the read zone of a preferred embodiment.

### BEST MODES FOR CARRYING OUT THE INVENTION

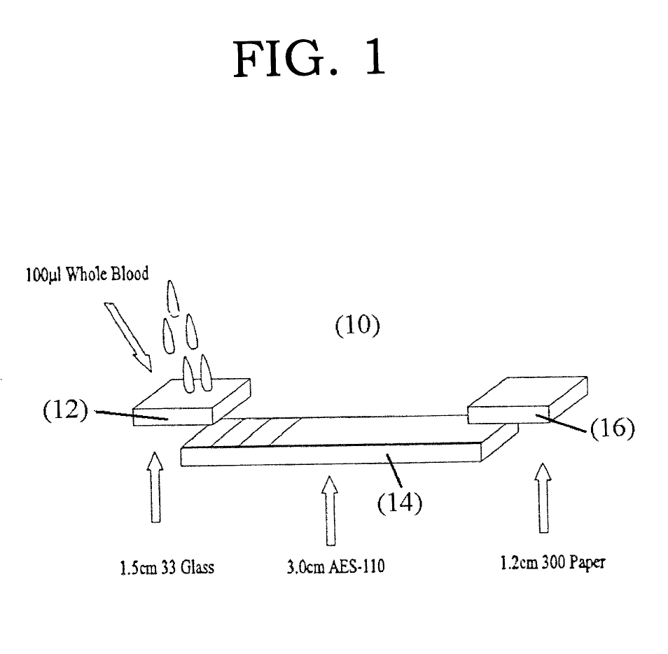

The present invention relates to the separation of plasma from whole blood on an analytical membrane. Once plasma has been separated from whole blood, it can be assayed on the same surface for a biochemical analyte or a protein antigen. The present invention is substantially different from the prior art in that one does not separate plasma from whole blood on one matrix, and then transfer the plasma to a second matrix for analysis. The present invention is greatly simplified compared to the current state of the field while retaining the ability to function in a lateral flow assay device. As shown in FIG. 1, a device (10) incorporating these principles comprises a single strip of nitrocellulose membrane. One end of the strip is a sample application zone (12). Abutting this zone is an area of an erythrocyte binding agent (EBA) within the nitrocellulose matrix. After this zone is a capture zone containing an analyte binding agent (14). Here, the nitrocellulose strip is available for placement of immobilized antibodies or antigens that can be used to react with an analyte or antigen in the plasma (assay chemistries). The EBA interacts with red blood cells slowing migration along the membrane pores, leaving the liquid portion of blood (plasma) to migrate to the distal end of the strip (16) where it can be assayed. This mechanism of separation is chromatographic in nature, as opposed to either agglutination or filtration mechanisms.

Lateral flow assays are standard techniques for the detection of antigens or analytes in fluids. For example, a common use of this technology is detection of human chorionic gonadotropin (hCG) for determining pregnancy. An hCG assay typically has a sample application area, an antibody release area, and an analytical membrane with one or more immobilized antibodies. As the sample flows through the antibody release area, the mobile antibody is released and migrates with the liquid front. If hCG is present an antigen-antibody complex will form during migration. The complex can then bind to an immobilized anti-hCG antibody on the analytical membrane. Typically the mobile antibody is linked to an enzyme or to a colloidal gold complex. If an enzyme-linked system is used, the antigen-antibody complex is visualized with a color producing enzymatic reaction. If a colloidal gold system is used, the complex is visualized by virtue of the red color of colloidal gold.

Plasma, the liquid component of whole blood, can contain antigens and analytes whose presence or absence may be of diagnostic value for some diseases. For example, it has been demonstrated recently that proteins called troponins are released into the blood after cardiac muscle damage that occurs during myocardial infarction (MI). Early detection of troponins at the point of care may help distinguish between patients with and without MI prior to entering the emergency room. Detection of troponins by lateral flow immunoassay is relatively easy as long as clear plasma is generated so that red blood cells do not interfere with antibody/antigen binding or interpretation of the colorimetric result. Some of the other uses for blood based-lateral flow immunoassay tests or lateral flow analyte tests that are coupled to plasma separation include infectious disease testing, e.g., malaria, hepatitis C virus and human immunodeficiency virus, as well as either clinical metabolic analyte tests for glucose and cholesterol or tumor marker testing, e.g., prostate specific antigen.

In a preferred embodiment, the present device includes a single strip of AES-10 (Schleicher and Schuell product #M02630) nitrocellulose membrane (having a polyester, non-woven support) that is about 0.67 cm in width and about 5.0 cm in length. (Suitable nitrocellulose membranes for the present invention include AES-11, commercially available from Schleicher & Schuell, Inc. of Keene New Hampshire.) A wick made from 300 grade cotton linter paper is attached to the distal end of the strip. In order to effect separation of blood components, a lectin, such as concanavalin A (Con A) is placed on the nitrocellulose. Preferably, three lines of Con A are placed on the nitrocellulose, with a distance of 0.4 centimeters between each line perpendicular to the direction of flow. In addition, optimal performance is achieved if the total amount of Con A is divided unequally among the three lines. For example, in one configuration where a total of 30 μg Con A is used, 5 μg would be in the first line, 10 μg in the second and 15 μg in the third. This gradient of Con A is preferred so as to avoid fouling the membrane with sample red blood cells.

### Performance

Several measurements of the above devices were made to determine the efficiency of the invention as well as the quality of plasma that is generated by the device. For each experiment, whole blood was used that had been collected in anti-coagulation ACD tubes (Acid, Citrate, Dextrose). Measurements were made on devices where 15 μl of whole blood from ACD tubes was applied to the application zone. PBS (25 μl) was added to the application zone two minutes later. The following metrics were used to compare different configurations: Wick Time (time after sample addition when the liquid front reaches the wick); Plasma migration distance to Red Blood Cell migration distance ratio (distance from the bottom of the strip to the plasma front compared to the distance from the bottom of the strip to the point where the red cells stopped moving (referred to in Table 1 as “Plasma/RBC”). In most cases the plasma migrated to the wick, a distance of 5 cm); and plasma composition was used as a test to compare various configurations.

Protein levels were examined as well as major protein banding patterns and glucose content of the plasma that was generated. This was done in order to ensure that the separation process did not alter the molecular content of plasma that was generated. The results are shown in Table 1 below.

TABLE 1

| Con A Configuration | Wick Time (min.) | Plasma/RBC |
|---|---|---|
| 0 μg | 5.2 ± 0.2 | 1.3 ± 0.0 |
| 5 μg/10 μg/15 μg | 6.2 ± 0.6 | 2.5 ± 0.2 |
| 10 μg/10 μg/10 μg | 5.5 ± 0.5 | 2.7 ± 0.2 |
| 30 μg | 5.7 ± 0.3 | 2.6 ± 0.3 |

All values represent the mean of at least three independent trials and standard error among those trials. Each trial consisted of 5 to 7 assay strips. Error between trials was insignificant.

Table 1 clearly demonstrates that the presence of Con A alters at which blood/plasma migrates through nitrocellulose only in a slight but insignificant fashion. Without Con A, however, there is almost no separation of plasma from red blood cells (P/RBC=1.3). When Con A is added to the nitrocellulose, substantial separation occurs (P/RBC˜2). The distance from the application zone to the bottom of the wick is 5 cm. Thus, for this configuration a P/RBC˜2 means that there is roughly 2.5 cm available for a diagnostic reaction in the “read zone.”

The most important question to be addressed for a blood separation method concerns the quality of the plasma that is generated. The ultimate goal of the separation process is to provide plasma that can be assayed for a protein or other analyte. If the separation process significantly alters the composition of the plasma, then its utility in an immunoassay situation is at risk. To address this question, the protein content of neat serum was analyzed before and after it was run on the device. Neat plasma was also analyzed and compared to plasma generated from whole blood on the device. Finally, because Con A binds sugar moieties, the glucose level in serum was measured before and after it was run on the device. The results of these studies are given below.

Removal of hemoglobin from plasma is one of the major objects for the present device. Polyacrylamide gel electrophoresis (SDS-PAGE) confirms that no hemoglobin was present in the read zone of strips with Con A addition. On a 4%-20% gradient gel, hemoglobin migrates at roughly 16.5 kDa. Protein eluted from the read zone of treated strips contained multiple bands but none that migrated at 16.5 kDa. Thus, not only were the red blood cells contained in the separation zone, but detectable hemolysis which would allow free hemoglobin to migrate up the strip did not occur.

Undiluted plasma was separated by SDS-PAGE and the proteins visualized by silver staining. Multiple bands were present indicating the major protein components of plasma. Plasma that was generated from whole blood on the device had a protein banding pattern on silver stained gels identical to that of undiluted plasma, indicating that no major proteins were removed during the separation process. Although this method does not identify specific proteins and is not sensitive enough to detect all proteins in plasma, it provides evidence that the separation process is not deleterious to plasma integrity.

The protein concentration of a human serum sample was determined to be 100 mg/ml. 40 μl of this sample was loaded onto strips with four different Con A configurations (0 μg Con A, 30 μg Con A, 10 μg, 10 μg, 10 μg Con A and 5 μg, 10 μg, 15 μg Con A). After 6 minutes, punches from the read zone of each strip were hydrolyzed and protein levels were determined by the fluorescamine method.

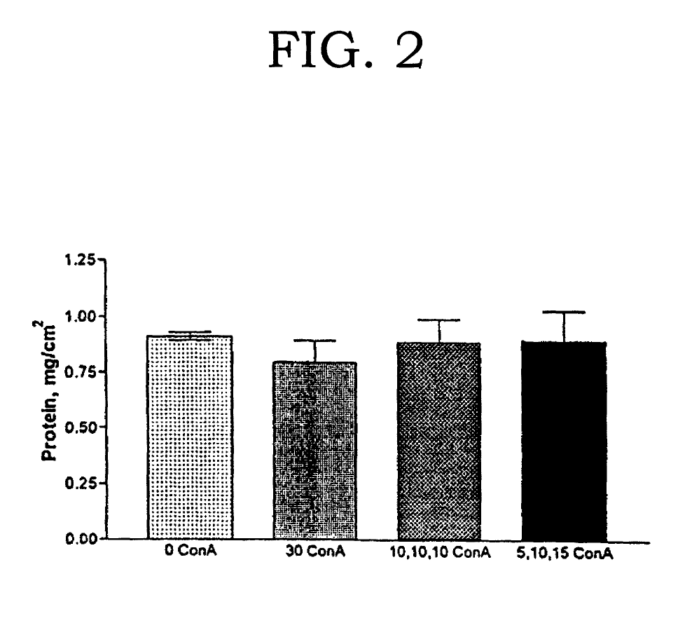

The amount of protein recovered from each configuration is shown graphically in FIG. 2 as mg/cm2 (averaged from 2 experiments done in duplicate). The results demonstrate that the presence of Con A on the nitrocellulose strip does not significantly affect the amount of protein that is recovered from the read zone.

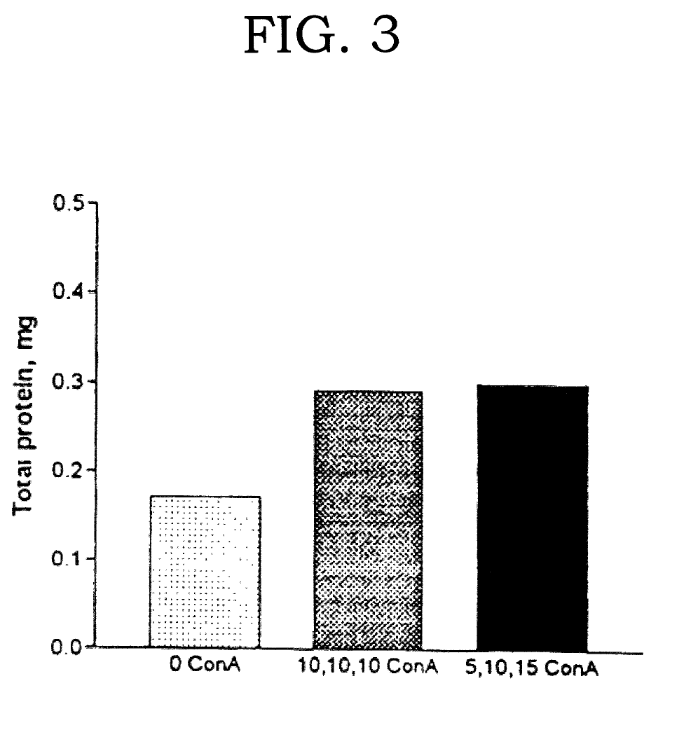

The effects of red blood cells on the passage of protein across the separation zone was examined. (See FIG. 3.) A sample of 15 μl of whole blood was placed on the application zones of various strip configurations, and protein levels were measured on punches taken from the read zone of each device. Values were normalized to the area of the read zones for each configuration. When no Con A was present, the read zone was very small, with only 0.172 mg available for analysis. Substantially more protein was available in the other configurations due to larger read zones.

The three stripe configurations allowed approximately 0.3 mg of protein to reach the read zone (FIG. 3). Based on the plasma protein concentration in these samples, that represents approximately 3.5 μl of plasma. The hematocrit of the whole blood sample was approximated at 50%, therefore 7.5 μl of plasma was applied for each 15 μl of whole blood. Previous experiments indicated that plasma was spread evenly over the AES-110, so with a P/RBC=2, the read zone constitutes half of the membrane. Thus, for 15 μl of whole blood, with a hematocrit of 50%, approximately 3.8 μl (15/4) of plasma should have been generated in the read zone. The recovery was 3.5 μl or 92% of the theoretical value. This data indicated that the separation method employed by the device to generate plasma is highly efficient.

The effect of Con A on the sugar content of plasma was examined. Glucose levels in human serum were measured with a commercially available glucose oxidase test purchased from Sigma Chemical Co. of St. Louis, Mo. The test was calorimetric with the end point read optically at 505 nm, and was linear for levels of glucose from 30 mg/dl to 300 mg/dL. To avoid problems related to hydrolysis and multiple dilutions, glucose levels were measured in serum directly off of nitrocellulose punches. Glucose levels were determined in serum from three sources. Samples were then applied to blood separation devices with and without Con A. After the serum had reached the wick, punches were taken from the read zone of each assay and placed in the reaction mix. The OD505 measurements were taken on the supernatant of these reactions.

The glucose results are presented in TABLE 2 as Percent Recovery from the actual recovered value versus the theoretical applied value.

TABLE 2

| | Percent | Percent |
|---|---|---|
| | Recovery | Recovery |
| SERUM | (No Con A) | (Con A) |
| 1 | 85% | 85% |
| 2 | 80% | 73% |
| 3 | 77% | 80% |

These results indicate that Con A does not alter the glucose levels in plasma or serum. Although the method of recovery is not 100% efficient, there is no difference in recovery with and without Con A, confirming the robustness of the present method.

In a preferred embodiment, one can increase the amount of blood that could be applied to the device by adding a sample application pad. Suitable materials for such pads are glass fibers, such as 33 grade glass. To control hemolysis, this glass should be impregnated with polyethylene glycol (PEG), 0.5% PEG dried to a final moisture content of about 1%. This device is shown in FIG. 1 and the design and specifications are listed below:

To assess protein migration over the device with a glass pad, 100 μl of plasma of known protein concentration was applied to a device comprised of 1.5 cm 33 Glass, impregnated with PEG 0.5%; 3.0cm of AES-110 nitrocellulose having Con A in three stripes 0.4 cm apart beginning 0.1 cm from bottom of AES-110; and a 1.2 cm 300 Paper wick. After the front had migrated to the wick, the strip was cut in half, separating the read zone and wick from the application and separation zones. Total protein on both halves was measured and the results are shown in Table 3.

TABLE 3

| | Protein (mg) | Protein (% Total) |
|---|---|---|
| Protein Applied | 8.0 | 100 |
| Protein Recovered in Application Zone | 3.9 | 49 |
| Protein Recovered in Read Zone | 3.5 | 44 |
| Total Protein Recovered | 7.4 | 93 |

These results indicate that the presence of the glass pad and the PEG does not interfere with migration of protein over the device.

The ordinarily skilled artisan can appreciate that the present invention can incorporate any number of the preferred features described above.

All publications or unpublished patent applications mentioned herein are hereby incorporated by reference thereto.

Other embodiments of the present invention are not presented here which are obvious to those of ordinary skill in the art, now or during the term of any patent issuing from this patent specification, and thus, are within the spirit and scope of the present invention.

We claim:

1. A novel device for separating plasma from a whole blood sample on a treated membrane comprising lateral flow chromatographic assay microporous membrane having a sample application zone, a separation zone, and an analysis zone, and an erythrocyte binding agent added to the membrane in an amount sufficient to bind any erythrocytes present in the sample.

2. The device of claim 1 wherein the membrane material consists of one of the following group: cellulose acetate, nitrocellulose, nylons, polyethersulfones, polypropylene, polyvinylidene flouride, and combinations thereof.

3. The device of claim 1 wherein the membrane has a porosity of about 1 micron to about 20 microns.

4. The device of claim 1 wherein the membrane is supported.

5. The device of claim 1 wherein the erythrocyte binding agent is added to one of the following membrane zones, the sample application zone and the separation zone.

6. The device of claim 1 wherein the erythrocyte binding agent is added to the membrane in one of the following geometries, a longitudinal gradient and a transverse row.

7. The device of claim 1 wherein the erythrocyte binding agent is an anti-erythrocyte antibody.

8. The device of claim 1 wherein the erythrocyte binding agent is a lectin that binds to sugar residues on the membranes of the red blood cells.

9. The device of claim 1 wherein a wick is placed at the membrane distal to a sample application zone.

10. The device of claim 1 wherein the device also comprises a sample application pad added to the sample application zone of the membrane.

11. The device of claim 7 wherein the sample application pad also comprises a moisture- retaining agent.

12. A method for separating plasma from a whole blood sample on a treated membrane comprising:
a) applying a whole blood sample to a microporous lateral flow chromatographic assay membrane having a sample application zone, a separation zone, and an analysis zone, and an erythrocyte binding agent added to the membrane in an amount sufficient to bind any erythrocytes present in the sample;
b) allowing sufficient time for any erythrocytes in the sample to bind to the binding agent, thereby separating plasma from the sample;
c) further allowing sufficient time for the sample plasma to migrate through the separation zone and into the analysis zone; and
d) analyzing the migrated plasma to determine the presence or amount of an analyte.

13. The method of claim 12 wherein the membrane material consists of one of the following group: cellulose acetate, nitrocellulose, nylons, polyethersulfones, polypropylene, polyvinylidene fluoride and combinations thereof.

14. The method of claim 12 wherein the membrane has a porosity of about 1 micron to about 20 microns.

15. The method of claim 12 wherein the membrane is supported.

16. The method of claim 12 wherein the erythrocyte binding agent is added to one of the following membrane zones, the sample application zone and the separation zone.

17. The method of claim 12 wherein the erythrocyte binding agent is added to the membrane in one of the following geometries, a longitudinal gradient and a transverse row.

18. The method of claim 12 wherein the erythrocyte binding agent is an anti-erythrocyte antibody.

19. The method device of claim 12 wherein the erythrocyte binding agent is a lectin that binds to sugar residues on the membranes of the red blood cells.

20. The method device of claim 12 wherein a wick is placed at the membrane distal to a sample application zone.

21. The method of claim 12 wherein the device also comprises a sample application pad added to the sample application zone of the membrane.

22. The method of claim 21 wherein the sample application pad also comprises a moisture-retaining agent.
